(19) United States
(12) Patent Application Publication
(10) Pub. No.: US 2026/0321455 A1
(43) Pub. Date: Oct. 15, 2026

(54) MULTI-CORE CABLE, METHOD FOR MANUFACTURING SAME, AND ELECTRONIC EQUIPMENT USING SAME

(71) Applicant: Junkosha Inc., Kasama-Shi (JP)

(72) Inventor: Akihiro OIWA, Ibaraki-Ken (JP)

(73) Assignee: Junkosha Inc., Kasama-Shi, IB (JP)

(21) Appl. No.: 19/101,406

(22) PCT Filed: Aug. 8, 2023
(86) PCT No.: PCT/JP2023/029010

§ 371 Date: Mar. 6, 2025

(30) Foreign Application Priority Data
Aug. 8, 2022 (JP) 2022- 126705

(51) Int. Cl. H01B 7/08

(52) U.S. Cl. CPC H01B 7/0823

(57) ABSTRACT

This multi-core cable includes a cable body portion, and a cable terminal processing portion. The cable terminal processing portion includes terminal portions of at least three ultra-thin cables among a plurality of ultra-thin cables, and a support plate. The terminal portion of the ultra-thin cable has an exposed terminal portion of the conductor. The support plate has a first side, a second side facing the first side, and has, on at least an upper surface of the support plate, a plurality of grooves extending from the first side to a direction of the second side. The terminal portion of the conductor includes a first area as an area overlapping with the support plate, and a second area as an area that does not overlap with the support plate. In the first area, at least part of the terminal portion of the conductor is located in the groove of the support plate. Some or all of the conductor located in the groove of the support plate has a flat portion that is, substantially parallel to the upper surface of the support plate. For two or more of the ultra-thin cables in the same cross-section, the conductors located in the grooves in the support plate satisfy the relationship r<A (expression (1)), where r is the radius of the conductor in the cable body portion, and A is the width of the flat portion of the conductor.

### TECHNICAL FIELD

The present invention relates to a multi-core cable including a plurality of ultra-thin insulated cables or a plurality of ultra-thin coaxial cables, a method of manufacturing the same, and an electronic device using the same.

### BACKGROUND ART

Recently, devices used in a variety of fields have been required to reduce the sizes thereof and to perform more accurate functions. Accordingly, an insulated cable or a coaxial cable used for various devices such as a measurement device, a communication device, a medical probe cable, and a micromachine is formed to have an extremely thin outer diameter in response to higher density of wiring arrangement on a substrate. In response to such requirement, for example, in the case of a coaxial cable, an ultra-thin coaxial cable having an extremely thin outer diameter of 0.16 mm or 0.10 mm is manufactured, and such an ultra-thin cable is used for an ultra-thin multi-core cable such as a round-type cable in which multiple ultra-thin cables are twisted together and a flat-type cable in which multiple cables are arranged in parallel.

Such a multi-core cable is connected to cable connection pads on a printed circuit board, which are arranged at a narrow pitch. In this case, since connection conductors are formed to be extremely thin, a worker needs to have an ability to perform, with a high level of precision, arrangement and connection processes for each of the connection conductors. As a result, as a cable becomes thinner, connection work becomes more complicated and takes more time. Accordingly, consistent and effective connection requires a great deal of skill. In addition, in terms of connection quality, various problems such as connection failure and deterioration in quality have occurred.

JP 2002-95129 A discloses a method of electrically connecting a central conductor of an ultra-thin coaxial cable to a connection portion provided on a substrate or the like, in which the method is performed in such a manner that the central conductors are aligned using a heat-transmitting member having alignment grooves formed therein and then are fixedly pressed against electrode portions of the substrate, thereby supplying infrared radiation through the heat-transmitting member having the groves formed therein. In this way, the cables may be collectively connected to the connection portion. However, when the aligned central conductors and the electrode portions of the substrate are collectively connected to each other, variations in connection strength and contact area between the central conductors and the electrode portions may occur.

In addition, JP 2003-143728 A discloses a connection method in which coaxial cables are respectively arranged in arrangement grooves formed in a base portion so as to be fixedly integrated with the base portion, each base portion is polished together with the coaxial cables to expose a central conductor and an outer conductor on the same plane, and a conductor circuit pattern member is fixed thereto. The above-mentioned connection method is expected to simplify manufacturing processes. Meanwhile, since a terminal portion of the central conductor is polished, the central conductor may break, and electrical characteristics such as a resistance value may be adversely affected by the volume loss of the conductor.

JP 2010-118318 A discloses a technique for electrically connecting central conductors of coaxial cables arranged on a flexible insulating sheet to respective electrode portions of a printed circuit board. The central conductors arranged on the flexible insulating sheet are heated by laser or the like and then are electrically connected to the respective electrode portions through a conductive adhesive. In the above-mentioned technique, the adhesive disposed on the flexible insulating sheet serves to appropriately align the central conductors arranged on the flexible insulating sheet. In this method, it is difficult to stably fix the position of the central conductor relative to the electrode portion on the substrate, and contact between conductive particles of the central conductor and the electrode portion is limited, which may cause variation in contact area of connection therebetween.

### CITATION LIST

### Patent Literature

Patent Literature 1: JP 2002-95129 A
Patent Literature 2: JP 2003-143728 A
Patent Literature 3: JP 2010-118318 A

### DISCLOSURE

### Technical Problem

Therefore, the present invention has been made in view of the above problems, and it is an object of the present invention to provide a multi-core cable through which a connection method is simply performed when conductors of ultra-thin cables arranged at a narrow pitch are electrically connected to respective electrode portions on a substrate, thereby having an effect of achieving excellent stability and reliability in terms of electrical connection between the conductors and the electrode portions.

### Technical Solution

In accordance with an aspect of the present invention, the above and other objects can be accomplished by the provision of a multi-core cable including a plurality of ultra-thin cables, each of the ultra-thin cables including a conductor and an insulator coated on an outer circumference of the conductor, wherein the multi-core cable includes a cable main body portion and a cable terminal processing portion, the cable terminal processing portion includes terminal portions of at least three ultra-thin cables among the plurality of ultra-thin cables and a support plate, the terminal portions of the ultra-thin cables are exposed terminal portions of the conductors, the support plate has a first side and a second side opposite the first side, the support plate has a plurality of grooves formed in at least an upper surface thereof, each of the grooves extending in a direction from the first side toward the second side, each of the terminal portions of the conductors includes a first region and a second region, the first region being a region overlapping with the support plate, the second region being a region not overlapping with the support plate, the first region has at least a part of the terminal portions of the conductors respectively located in the grooves in the support plate, Some or all of the conductors respectively located in the grooves in the support plate have respective flat portions approximately parallel to the upper surface of the support plate, and the conductors respectively located in the grooves in the support plate satisfy a relationship of r<A (Equation (1)) with respect to two or more of the conductors in the same cross-section, wherein r is a radius of the conductor in the cable main body portion, and A is a width of the flat portion of the conductor.

According to the above-described configuration, the terminal portions of the conductors may be readily arranged at a narrow pitch particularly by using the support plate having the grooves formed in the upper surface of the support plate. Since the conductors are arranged in the respective grooves in the support plate, the conductors may be collectively connected to the respective electrode portions. In addition, some or all of the conductors located in the respective grooves in the support plate has the flat portion that is approximately parallel to the upper surface of the support plate. Accordingly, it is possible to readily obtain a stable electrical connection between the conductors and the electrode portions.

A cross-sectional shape of each of the conductors located in the respective grooves in the support plate may be configured such that a ratio (D2/D1) of a maximum width D2 of the conductor in a direction parallel to the flat portion of the conductor to a maximum height D1 of the conductor in a direction perpendicular to the flat portion of the conductor is 1.0<(D2/D1)<2.0.

In order to stably perform electrical connection between the conductors and the electrode portions, a sufficient area of the flat portions of the conductors facing the substrate can be secured, and an interval between the conductors can also be secured.

The terminal portions of the conductors may be arranged in parallel in the first region which is an area overlapping with the support plate. The interval between the conductors may range from 0.04 mm to 1.0 mm.

Each of the conductors in the cable main body portion may have an outer diameter ranging from 0.01 mm to 0.15 mm. In the present invention, high effectiveness may be obtained in a cable having an outer diameter of a conductor of 0.01 mm to 0.1 mm, and when the outer diameter is 0.01 to 0.05 mm, effectiveness is particularly easily obtained.

A difference between a cross-sectional area of the conductor in the cable main body portion and a cross-sectional area of the terminal portion of the conductor located in the groove in the support plate may be within 10.0% of the cross-sectional area of the conductor in the cable main body portion. The difference is preferably within 5.0%. Since the cross-sectional area of the conductor is hardly changed in the vicinity of a connection portion between the electrode portion and the conductor, an adverse effect on the electrical characteristics may be suppressed.

A cross-sectional area of the groove in the support plate may be 97% or less of the cross-sectional area of the conductor located in the groove in the support plate. In addition, the cross-sectional area of the groove in the support plate is preferably 40% to 97% of a cross-sectional area of the conductor located in the groove in the support plate. The cross-sectional area preferably ranges from 50% to 95%. When the cross-sectional area of the groove formed in the support plate is smaller than the cross-sectional area of the conductor, the conductor located in the groove in the support plate stably protrudes from the upper surface of the support plate even if the conductor is pressed from above. In a state in which the flat portion of the conductor located in the groove in the support plate protrudes from the upper surface of the support plate, when the multi-core cable of the present invention is electrically connected to the electrode portions with an anisotropic conductive film interposed therebetween, pressure is easily concentrated on a connection portion between each of the electrode portions and a corresponding one of the conductors, thereby achieving stable and reliable electrical connection therebetween.

Additionally, when the grooves in the support plate are arranged in parallel, an interval between the grooves in the support plate may range from 0.04 mm to 1.0 mm. The interval between the grooves in the support plate corresponds to an interval between the conductors of the multi-core cable connection portion. In order to obtain an effect of reducing the size of the periphery of the substrate and the connection portion of the multi-core cable, the interval between the grooves may range from 0.05 mm to 1.0 mm, 0.04 mm to 0.5 mm, or 0.04 mm to 0.4 mm. The arrangement of the grooves in the support plate may be determined corresponding to the arrangement of the electrode portions to which the multi-core cable is to be connected, and the interval between the grooves arranged in parallel may be uniform or non-uniform. Furthermore, in addition to the parallel arrangement of the grooves in the support plate, the grooves in the support plate may be arranged in a radial shape extending in the direction from the first side of the plate toward the second side thereof. Further, the grooves in the support plate may extend not only linearly in the direction from the first side of the plate toward the second side thereof. Here, each of the grooves may be formed to have a curved shape.

The support plate may be formed of an insulating material. In addition, the support plate may be formed to have appropriate hardness.

In the multi-core cable of the present invention, the conductors respectively located in the grooves in the support plate and electrode portions on a connection substrate may be electrically connected to each other with an anisotropic conductive film interposed therebetween. The above-described connection through the anisotropic conductive film interposed between the conductor and the electrode portion eliminates the occurrence of short circuit caused by solder attached between adjacent conductors or electrode portions in the vicinity of the connection portion, thereby having an effect of improving reliability and stability of electrical connection. In addition, the multi-core cable of the present invention has a flat portion formed on the conductor located in the groove in the support plate and oriented toward the substrate, in which the flat portion protrudes from the upper surface of the support plate. Here, when the conductors are electrically connected to the respective electrode portions with the anisotropic conductive film interposed therebetween, pressure is easily concentrated on a connection portion between each of the electrode portions and a corresponding one of the conductors, thereby making it possible to collectively connect the conductors integrated into the support plate to the respective electrode portions. In addition, it is easy to capture conductive particles between the electrode portions and the flat portions of the conductors, thereby having an effect of implementing highly stabile and reliable connection therebetween.

In accordance with another aspect of the present invention, there is provided an electronic device including any one of the above-described multi-core cables.

In accordance with a further aspect of the present invention, there is provided a method of manufacturing a multi-core cable, the method including the steps of preparing a plurality of ultra-thin cables, each of the ultra-thin cables including a conductor and an insulator coated on an outer circumference of the conductor, removing the insulators of terminal portions of the plurality of ultra-thin cables and exposing the conductors, preparing a support plate having a first side and a second side opposite the first side, the support plate having a plurality of grooves formed in at least an upper surface thereof, each of the grooves extending in a direction from the first side toward the second side, arranging the conductors exposed by removing the respective insulators in the respective grooves formed in the support plate, and pressing the conductors arranged in the respective grooves from above the support plate to fit the conductors into the respective grooves in the support plate, and forming flat portions on the respective conductors arranged in the grooves, the flat portions being formed to be approximately parallel to the upper surface of the support plate.

### Advantageous Effects

A multi-core cable of the present invention is capable of connecting ultra-thin insulated cables or ultra-thin coaxial cables to respective electrode portions arranged at a narrow pitch. The multi-core cable of the present invention has a structure enabling stable and reliable electrical connection between the cables and the electrode portions through a simple method. Accordingly, the multi-core cable of the present invention is highly effective in manufacturing electronic devices having stable electrical characteristics.

### DESCRIPTION OF DRAWINGS

The above and other objects, features and other advantages of the present invention will be more clearly understood from the following detailed description taken in conjunction with the accompanying drawings, in which:

FIG. 1 is a view showing an example of a multi-core cable according to the present invention;

FIG. 2 is a schematic view of a cross section of a terminal portion of an example of an ultra-thin insulated cable;

FIG. 3 is a schematic view of a cross section of a terminal portion of an example of an ultra-thin coaxial cable;

FIG. 4 is a view showing the vicinity of a terminal portion of an example of a cable;

FIG. 5 is a schematic view of an example of a support plate used in the present invention;

FIG. 6 is a view showing an example of a cross section of the support plate;

FIG. 7 is a view showing a state in which conductors are arranged on the support plate;

FIG. 8 is a schematic cross-sectional view showing a state in which the conductors are arranged on the support plate;

FIG. 9 is a schematic cross-sectional view showing a state in which the conductors are arranged on the support plate;

FIG. 10 is a partially enlarged view of the schematic cross-sectional view showing the state in which the conductors are arranged on the support plate;

FIG. 11 is a view showing an example of a cross-sectional shape of the conductor on the support plate;

FIG. 12 is a view showing another example of the cross-sectional shape of the conductor on the support plate;

FIG. 13 is a view showing still another example of the cross-sectional shape of the conductor on the support plate;

FIG. 14 is a view showing a cross-sectional area of a groove in the support plate;

FIG. 15 is a view showing another example of the support plate;

FIG. 16 is a schematic view of the vicinity of a cable terminal processing portion when a cable is connected to an electrode portion;

FIG. 17 is a schematic cross-sectional view of the cable terminal processing portion when the cable is connected to the electrode portion; and

FIG. 18 is a schematic cross-sectional view of the cable terminal processing portion when the cable is connected to the electrode section.

### BEST MODE

Hereinafter, the structure of a multi-core cable according to an embodiment of the present invention will be described with reference to the accompanying drawings. It is noted that the embodiment described below is not intended to limit the technical scope of the present invention, and all of the combinations of the features described in the embodiment are not necessarily essential to means provided by aspects of the invention.

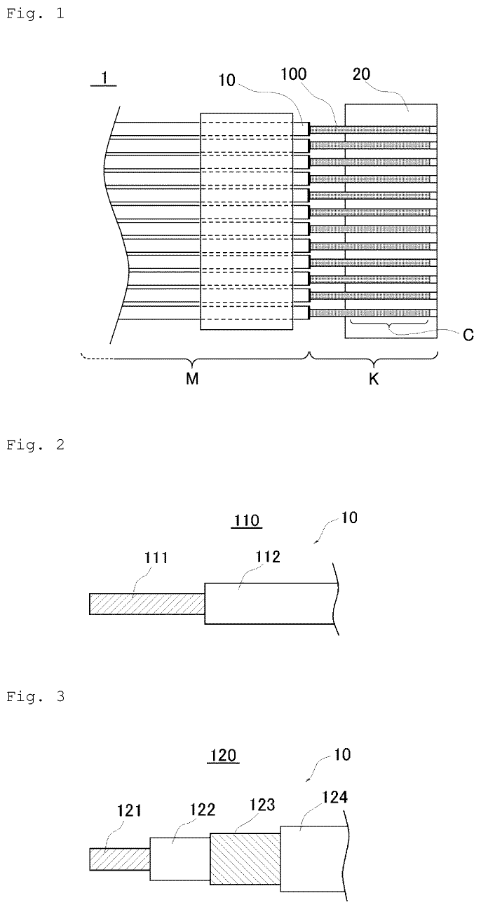

FIG. 1 is a diagram illustrating the structure of a multi-core cable according to an embodiment of the present invention. A multi-core cable 1 may be broadly divided into a cable main body portion M and a cable terminal processing portion K. FIG. 1 is a view showing the vicinity of the cable terminal processing portion K of the cable main body portion M and the cable terminal processing portion K. Multiple ultra-thin cables 10 are arranged side by side in a planar shape in the vicinity of the cable terminal processing portion K. In the cable terminal processing portion K, an insulator of a terminal portion of each of the ultra-thin cables 10 is removed by a predetermined length, and a part of the terminal portion of an exposed conductor 100 is located in a groove 210 formed in a support plate 20. The terminal portion of the conductor 100 includes a first region C1 overlapping with the support plate 20 and a second region C2 not overlapping with the support plate 20. Depending on a structural configuration of the terminal portion, the length of the second region C2 may be formed to be almost zero. In the example shown in FIG. 1, eight ultra-thin cables 10 are arranged in parallel, but the number of ultra-thin cables 10 arranged in parallel may be about 3 to 100. That is, the number of ultra-thin cables to be arranged in parallel may be appropriately determined depending on the connection process. The cable main body portion M (an area excluding the terminal processing portion K) may be formed as a cable having a circular cross section in which the multiple ultra-thin cables 10 are twisted together or a cable having a flat cross section in which the multiple ultra-thin cables 10 are arranged in parallel. The multi-core cable of the present invention may be configured such that one multi-core cable includes a plurality of support plates 20.

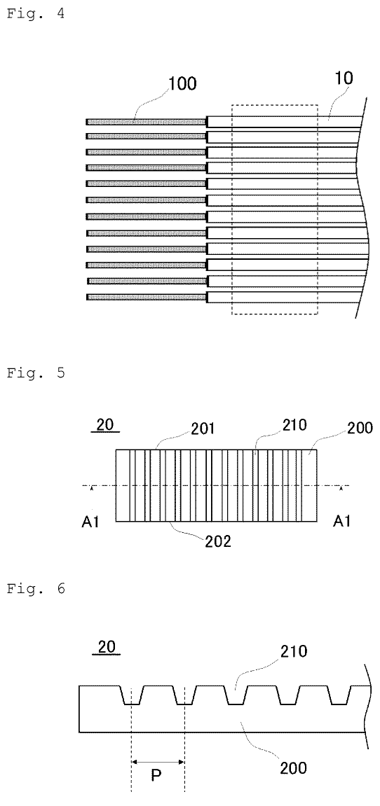

The ultra-thin cable 10 includes a conductor and an insulator coated on the outer circumference of the conductor. The ultra-thin cable 10 may be an ultra-thin insulated cable that is formed of a conductor and an insulator or an ultra-thin coaxial cable further including a shield conductor on the outer circumference of the insulator. The cable forming the multi-core cable of the present invention may be formed of only the ultra-thin insulated cable or only the ultra-thin coaxial cable or may be formed of a combination of the ultra-thin insulated cable and the ultra-thin coaxial cable. In addition to the ultra-thin insulated cable or the ultra-thin coaxial cable, the cable forming the multi-core cable of the present invention may be a cable in which a long body such as an uncoated wire or a tube is mixed and arranged with an ultra-thin cable. FIGS. 2 and 3 are schematic views each showing a cross section of a terminal portion of an example of the ultra-thin cable 10 forming the multi-core cable of the present invention. FIG. 2 is a view showing an example of an ultra-thin insulated cable 110. The ultra-thin insulated cable is a cable in which an insulator 112 is coated on the outer circumference of a conductor 111 having an outer diameter ranging from 0.01 mm to 0.15 mm. FIG. 3 is a view showing an example of an ultra-thin coaxial cable 120. The ultra-thin coaxial cable is an ultra-thin cable in which an insulator 122 is coated on the outer circumference of a conductor 121 having an outer diameter ranging from 0.01 mm to 0.15 mm, a shield conductor 123 having a shield element wire horizontally wound therearound is provided on the outer circumference of the insulator 122, and a jacket 124 is further coated on the outer circumference of the shield conductor. Each of the conductors 111, 121, and the shield conductor 123 may employ a wire material generally used as a conductor. The wire material may be made of copper, silver, aluminum, steel, various alloys, and the like. The wire material, the surface of which is coated with plating of silver, tin, or the like, is generally used. For example, a silver-plated copper alloy wire may be used. The conductors 111 and 121 may be either a solid wire or a twisted wire, and may be parallel without being twisted.

Hereinafter, the cable terminal processing portion K of the multi-core cable of the present invention will be described in detail. The multi-core cable of the present invention may be a cable having a circular cross section or a cable having a flat cross section in the cable main body portion. Preferably, the cables are arranged flat in the cable terminal processing portion K. Further, the cable terminal processing portion K including one support plate may also be formed using a cable having a plurality of circular cross sections or a cable having a flat cross section.

FIG. 4 is a view showing the vicinity of a terminal portion of an example of a cable. Here, FIG. 4 shows a state in which a conductor is not disposed on a support plate in the terminal portion of the cable. In the terminal portion of the cable, the insulators of the ultra-thin cables 10 arranged in parallel are each removed by a predetermined length so as to expose the conductors 100 of the respective terminal portions. At least a part of the exposed terminal portion of the conductor 100 is placed in a groove formed in the support plate.

FIG. 5 is a schematic view of an example of the support plate 20. The support plate 20 is made of an insulating material, and a thin plate-shaped material having a thickness of, for example, 0.02 mm to 0.20 mm may be used for the support plate. The thickness may be appropriately set to 0.03 mm to 0.10 mm depending on hardness of the material. An insulating material having heat resistance may be suitably used. For example, polyimide (PI) resin, polyamide-imide (PAI) resin, polyether ether ketone (PEEK) resin, polyphenylene sulfide (PPS) resin, tetrafluoroethylene-perfluoroalkyl vinyl ether copolymer (PFA), polytetrafluoroethylene (PTFE), and the like may be used as the insulating material, but the present invention is not limited thereto. Further, as a material of the plate 200, a material having a suitable hardness is preferable. When the conductor disposed in the groove 210 in the support plate 20 is pressed from above the support plate 20, the conductor 100 is readily fitted into the groove 210, and then at least a part of the terminal portion of the conductor 100 is readily and continuously disposed in the groove 210 in the support plate 20 until the multi-core cable is connected to the electrode portion or the like. In addition, since it is easy to simultaneously apply pressure to a plurality of conductors, it is possible to reliably and stably connect the conductors to the respective electrode portions.

FIG. 5 is a view of the support plate 20 viewed from above and is a view showing the upper surface of the support plate 20. The support plate 20 has a first side 201 and a second side 202 opposite the first side 201. A plurality of grooves 210 each extending in a direction from the first side 201 toward the second side 202 is formed in the upper surface of the support plate 20. Each of the grooves 210 is formed to have a shape and an interval corresponding to arrangement of the electrode portions connected to the multi-core cable, and the exposed conductors 100 of the terminal portions of the ultra-thin cables 10 are respectively arranged in the grooves 210.

FIG. 6 is a view showing an example of a cross section of the support plate 20 and is a view showing a cross section taken along A1-A1 in FIG. 5. The grooves 210 are formed in the upper surface of the support plate 20 with a predetermined interval P therebetween, and the opening side of each of the grooves becomes the surface facing the electrode portion when the multi-core cable is connected to the electrode portion. A distance between a central portion of a width of an opening portion of a groove and a central portion of a width of an opening portion of an adjacent groove is defined as the interval P between the grooves 210 in the support plate, and the interval P between the grooves 210 may range, for example, from 0.04 mm to 1.0 mm. In particular, a technique of the present invention may be applied to a case in which an electrode portion to be connected to the multi-core cable is very thin and dense. Further, the technique may be applied to a step in which the conductors of the ultra-thin cables 10 are respectively connected to the electrode portions on the substrate with an interval of, for example, 0.10 mm or 0.05 mm therebetween.

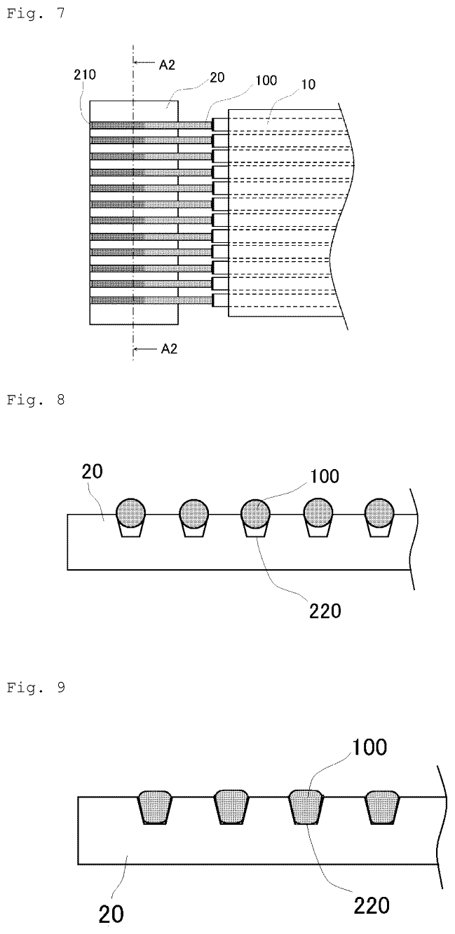

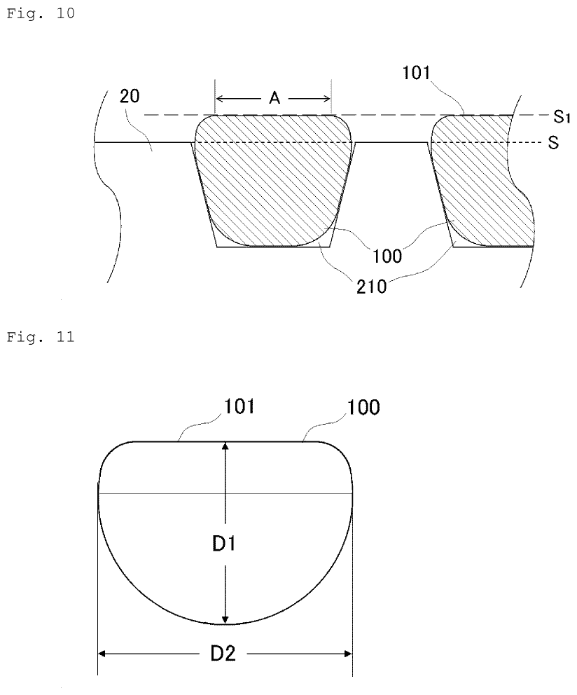

At least a part of the exposed conductor 100 of the terminal portion of the ultra-thin cable 10 is disposed in the groove 210 formed in the support plate 20 described above. FIG. 7 is a view showing a state in which the conductors 100 of the terminal portions of the ultra-thin cables 10 are arranged in the respective grooves 210 formed in the support plate 20. The exposed conductors 100 of the cable terminal portions are arranged on the support plate in a state of being aligned according to the arrangement of the grooves 210. FIG. 8 is a cross-sectional view taken along line A2-A2 in FIG. 7 and shows a state in which the conductors 100 are aligned in the respective grooves 210 in the support plate 20. FIG. 8 is a schematic view of the conductor terminal portion and the support plate 20 in a case where the conductor 100 disposed in the groove 210 is pressed from above the support plate 20 so as to fit the conductor 100 into the groove 210 as an example of a method of arranging the conductors of the cable terminal portions on the support plate. In this method, an insulating material that has a suitable hardness and is elastically deformable may constitute the support plate 20, and a cross-sectional area of the groove 210 may be formed to be smaller than a cross-sectional area of the conductor 100. The conductor 100 is disposed in the groove 210 and then is pressed thereinto, thereby making it possible to readily fit the ultra-thin cable into the support plate. When it is required to more stably fix the cable to the support plate, an adhesive layer may be provided in the groove. For example, a thermosetting resin such as an epoxy resin or an ultraviolet curing resin may be used as an adhesive.

FIG. 9 is a cross-sectional view taken along line A2-A2 in FIG. 7 when the conductors 100 of the terminal portions of the ultra-thin cables are fitted into the support plate 20. A surface located on the upper side of FIG. 9 is an upper surface of the support plate 20, in which the surface is a surface facing an electrode portion. Some or all of the conductor 100 located in the groove 210 in the support plate 20 has a flat portion 101 that is approximately parallel to the upper surface of the support plate 20. Since the conductor, the surface of which faces the electrode portion, has the flat portion that is approximately parallel to the upper surface of the support plate 20, it is easy to secure an area in which a gap between each of the conductors and a corresponding one of the electrode portions has an equal distance, thereby having an effect of improving stable electrical connection therebetween.

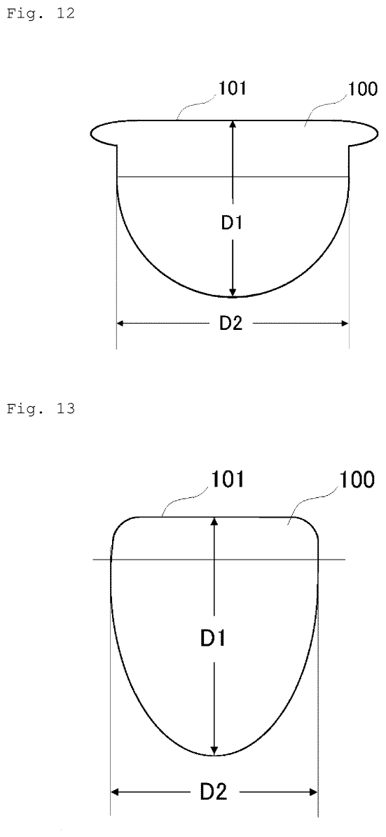

FIG. 10 is an enlarged view of the vicinity of the conductor 100 in FIG. 9. A width A of the flat portion 101 of the conductor 100, which is approximately parallel to the upper surface of the support plate 20, is preferably equal to or greater than a radius r of the conductor in the cable main body portion, and the width A of the flat portion 101 is preferably formed to maximally extend within a range satisfying the configuration of the present invention. As the outer diameter of the conductor becomes thinner, it becomes more difficult to connect the conductor to the electrode portion in terms of aligning the connection positions between the conductors and the electrode portions and ensuring connection areas therebetween. Meanwhile, when the width of the flat portion is equal to or greater than the radius r of the conductor, stable electrical connection between the conductors and the electrode portions may be advantageously performed. The flat portion 101 of the conductor 100, which is approximately parallel to the upper surface of the support plate 20, may be formed before the conductor is disposed in the groove in the support plate or may be formed by deforming the conductor 100 when the conductor 100 is fitted into the groove 210 in the support plate. In addition, preferably, the flat portion 101 of the conductor 100, which is approximately parallel to the upper surface of the support plate 20, is on the same plane as the upper surface of the support plate or is formed to protrude upwards from the upper surface of the support plate. Referring back to the cross-sectional view of FIG. 9, the height of each of the flat portions 101 of the conductors 100 arranged on the upper surface of the support plate 20 may be formed to be aligned on the same straight line as a straight line (a surface line) S along the front surface of the upper surface of the support plate or on a straight line (for example, a straight line S1) approximately parallel to the surface line S. In the present invention, the meaning of “one component is approximately parallel to the other component” includes not only “one component is perfectly parallel to the other component” but also “one component is substantially parallel to the other component within a certain error range”.

For example, when conductors having different outer diameters are arranged on the support plate, the depth and cross-sectional area of the groove 210 may be appropriately adjusted. In this manner, the height of the flat portion 101 of each of the conductors in the support plate may be aligned on the same straight line as the surface line S of the support plate or on the straight line approximately parallel to the surface line S. The flat portion of the conductor faces the electrode portion to be connected. For example, when the conductor and the electrode portion are connected to each other by solder or conductive paste, the relative position and distance between the electrode portion and the conductor may be stabilized through the flat portion of the conductor, thereby making it possible to increase a connection area between the conductor and the electrode portion. In addition, in a state in which the height of the flat portion 101 of the conductor is larger than the height of the upper surface of the support plate, for example, when an anisotropic conductive film is used for connection between the conductor and the electrode portion, pressure is easily concentrated on a joint portion between the electrode portion and the conductor, thereby having an effect of implementing stable and reliable connection between the electrode portion and the conductor.

It is preferable to have little change in the cross-sectional area of the conductor of the ultra-thin cable electrically connected to the electrode portion. Specifically, an absolute value of a difference between the cross-sectional area of the conductor in the cable main body portion and the cross-sectional area of the conductor of the terminal portion, which is located in the groove in the support plate, is preferably within 10.0% of the cross-sectional area of the conductor in the cable main body portion, and is more preferably within 5.0%. It is conceivable that a small change in the cross-sectional area of the conductor reduces an adverse effect on the electrical characteristics.

FIG. 11 is a diagram illustrating an example of the cross-sectional shape of the conductor 100 arranged on the support plate. The cross-sectional shape of the conductor 100 located in the groove in the support plate may be formed so that a maximum height D1 of the conductor in a direction perpendicular to the flat portion of the conductor and a maximum width D2 of the conductor in a direction parallel to the flat portion 101 of the conductor have a relationship of D1<D2. Furthermore, a ratio (D2/D1) of the maximum width D2 of the conductor in the direction parallel to the flat portion of the conductor (also referred to hereinafter as the maximum width D2 of the conductor) to the maximum height D1 of the conductor in the direction perpendicular to the flat portion of the conductor (also referred to hereinafter as the maximum height D1 of the conductor) may be greater than 1.0 and less than 2. The ratio of D2/D1 may also be greater than 1.0 and less than 1.8. When the ratio of D2 to D1 is within this range, it is easy to simultaneously secure a preferable structure for connection between the electrode portion and the conductor and a distance between the conductors.

FIGS. 12 and 13 are views each showing another example of the cross-sectional shape of the conductor 100 located in the groove in the support plate. For example, as shown in FIG. 12, the cross section of the conductor 100 located in the groove in the support plate may be formed to have a shape so that an upper portion of the conductor extends in a flange shape. In the case of such a shape, the maximum width D2 of the conductor is measured by excluding a specific shaped portion such as a flange-shaped portion or a protrusion. The shape shown in FIG. 12 makes it easy to secure a length A of the flat portion when the conductor is particularly thin such that it is difficult to secure the length A of the flat portion of the connection side of the conductor. Furthermore, as shown in FIG. 13, for example, the maximum height D1 of the conductor may be formed to be larger than the maximum width D2 of the conductor according to the shape of the groove.

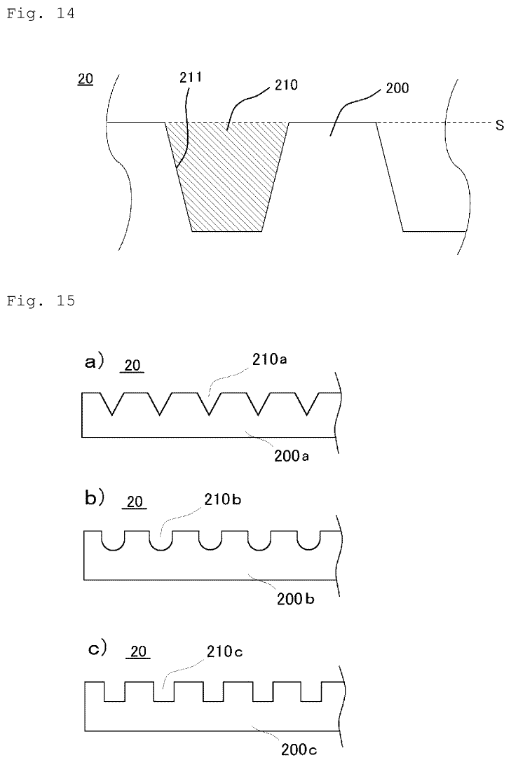

Preferably, a relationship between the size of the conductor located in the groove in the support plate and the size of the groove in the support plate is configured such that the cross-sectional area of the groove in the support plate is smaller than the cross-sectional area of the conductor located in the groove in the support plate. The cross-sectional area of the groove 210 formed in the support plate is preferably 97% or less of the cross-sectional area of the conductor 100 located in the groove in the support plate. More preferably, the cross-sectional area of the groove formed in the support plate is 40% to 95% of the cross-sectional area of the conductor located in the groove in the support plate. When the cross-sectional area of the groove in the support plate is formed to be smaller than 40% of the cross-sectional area of the conductor, it may be required to use an adhesive in the groove or to form a groove having a special shape. As shown in FIG. 14, the cross-sectional area of the groove 210 may be measured by photographing, with a digital microscope or the like, a cross section (a transverse section) cut in a direction perpendicular to the longitudinal direction of the groove in the support plate. An area surrounded by a surface line S of the upper surface of the support plate 210 and a line 211 of the inner surface of the groove 210 in the support plate (for example, a hatched portion in FIG. 14) becomes a cross-sectional area of the groove 210. When an insulating material different from a material of the main body of the plate 200, such as an adhesive, is included in the groove 210, a cross-sectional area of the groove, which is occupied by the insulating material, is not regarded as the cross-sectional area of the groove 210.

FIG. 15 is a view showing another example of the support plate. In the above description, the groove 210 in the support plate 20 has a trapezoidal cross section. Here, the shape of the groove 210 is not particularly limited as long as the shape enables the conductor to be easily placed in the groove. For example, a V-shaped groove 210a shown in FIG. 15a), a semicircular groove 210b shown in FIG. 15b), or a square groove 210c shown in FIG. 15c) may be used. When the conductors 100 are arranged at a narrow pitch, the ratio of the width of the groove 210 to the depth of the groove 210 (width/depth) is preferably less than 2.

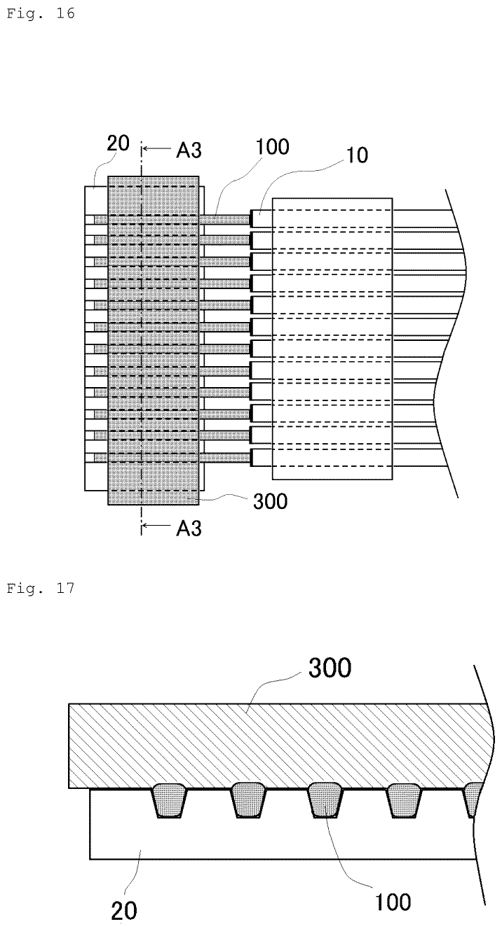

In the multi-core cable of the present invention, the conductor and the electrode portion may be connected to each other not only through solder or conductive paste, but also through an anisotropic conductive film interposed therebetween. The anisotropic conductive film is formed to have a film shape obtained by dispersing conductive particles such as fine metal particles based on a thermosetting resin. In a state in which the anisotropic conductive film is interposed between the conductor and the electrode, heat and pressure are applied to the film, the conductive particles dispersed in the film approach each other and come into contact with each other so as to be electrically connected to each other. In the case of a portion of the film where pressure is not applied, an insulation around the conductive particles is maintained. Accordingly, the portion of the film has a property of maintaining insulation between the electrodes in the lateral direction. FIG. 16 is a schematic view of the vicinity of the cable terminal processing portion when the conductor located in the groove in the support plate and the electrode portion to be connected to the conductor are electrically connected to each other with an anisotropic conductive film interposed therebetween. The conductors 100 of the terminal portions of the ultra-thin cables 10 arranged in parallel are respectively fitted into the grooves formed in the support plate 20, and an anisotropic conductive film 300 is laminated on the upper portion of the support plate 20 and the conductors 100. Since the anisotropic conductive film 300 is laminated on the support plate 20 and the conductors 100, it is possible to prevent the conductors 100 from being separated from the respective grooves in the support plate 20. As described above, the ultra-thin cable may be transported in a state of being integrated with the support plate. Accordingly, it is possible to transport the ultra-thin cable in a state of being able to be connected to the electrode portion only through heating and pressurization with respect to the anisotropic conductive film.

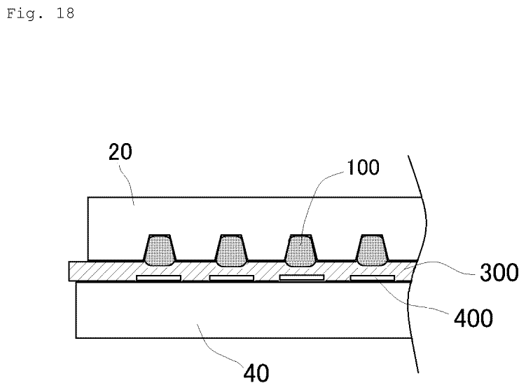

FIGS. 17 and 18 are cross-sectional views each showing the cable terminal processing portion in the example of FIG. 16, and are schematic views each showing the cross section taken along line A3-A3 in FIG. 16. In FIG. 17, the anisotropic conductive film 300 is arranged on the support plate 20 and the conductors 100. In the multi-core cable of the present invention, when a support plate corresponding to the arrangement of the electrode portions of a substrate or the like is used, the support plate on which the conductors are arranged may be directly connected to the respective electrode portions of the substrate using an anisotropic conductive film. The support plate of the present invention may be formed to be thin. Here, when an anisotropic conductive film having a light-transmitting property is used, the position of an electrode pad may be confirmed through the support plate and the anisotropic conductive film. In FIG. 18, the surface of the anisotropic conductive film disposed on the support plate 20 and the upper portion of the conductor 100 is attached to corresponding electrode portions 400 of a substrate 40, and then heat and pressure are applied to a portion between the support plate 20 and the electrode portions 400, thereby electrically connecting the electrode portions 400 to the respective conductors 100. The multi-core cable of the present invention has some or all of the conductor located in the groove in the support plate has a flat portion that is approximately parallel to the upper surface of the support plate, and the conductive particles contained in the anisotropic conductive film are easily held between the flat portions of the conductors and the convex portions of the electrode portions. Accordingly, it is easy to hold the sufficient number of conductive particles for electrical connection between the conductors and the electrode portions and to form a conductive path. In particular, when the flat portions of the conductors protrude upwards from the upper surface of the support plate, pressure is easily concentrated on a connection portion between each of the electrode portions and a corresponding one of the conductors, thereby achieving stable and reliable electrical connection between the conductors and the electrode portions.

Here, the structure of the multi-core cable of the present invention has been described, and the multi-core cable of the present invention is manufactured through the following steps. The prevent invention may not be limited to the following order of the steps to be described below.

### Step of Preparing Ultra-Thin Cable

As an ultra-thin cable, an ultra-thin insulated cable and/or an ultra-thin coaxial cable are prepared. Generally, a cable main body portion is a cable having a circular cross section obtained by twisting a plurality of ultra-thin cables, or a cable having a flat cross section obtained by arranging the plurality of ultra-thin cables in parallel.

### Step of Exposing Conductor

An insulator of each of the terminal portions of the prepared ultra-thin cables is removed to expose a conductor. When the ultra-thin coaxial cable is used, a jacket, a shield conductor, and an insulator are sequentially removed from the outer circumference of the cable, thereby exposing the conductor.

### Step of Preparing Support Plate

A support plate having a first side and a second side opposite the first side is prepared. Here, the support plate has a plurality of grooves formed in at least the upper surface thereof, in which each of the grooves extends in a direction from the first side toward the second side. A film to be used as a material for the support plate is prepared, and a groove is formed by processing the film with a laser or the like.

### Step of Arranging Conductors in Support Plate

The conductors exposed by removing the respective insulators are respectively arranged in the grooves formed in the prepared support plate.

Step of Fitting Conductors into Respective Grooves in Support Plate

The conductors respectively arranged in the grooves in the support plate are pressed from above the support plate so as to be fitted into the respective grooves in the support plate. In addition, flat portions each formed to be approximately parallel to the upper surface of the support plate are formed on the conductors respectively arranged in the grooves in the support plate.

The multi-core cables of the present invention may be respectively connected to fine electrode portions arranged at high density, and each of the multi-core cables has excellent stability and reliability in terms of electrical connection with the electrode portion. The multi-core cable of the present invention is also highly effective in reducing the size of an area around a substrate connection portion. Accordingly, an electronic device including any one of the above-mentioned cables of the present invention may be used as an electronic device in various fields requiring miniaturization and high precision of devices such as a medical imaging device, a micromachine, a measuring device, and a communication device.

### EMBODIMENT

### Measurement of Cross-Sectional Shape of Conductor

The cross-sectional shape of a conductor of a cable terminal processing portion, which is located in a groove in a support plate, is measured by cutting the conductor so that the shape of a measurement portion of the conductor is maintained, and a cross section of the conductor is created. For example, when the vicinity of the measurement portion is embedded in a hardening resin or the like and then cut, the cross section of the measurement portion may be created while maintaining the shape. The cross section is measured using a digital microscope or the like. The measurement position is set near a central portion in the longitudinal direction of a first region in which the terminal portion of the conductor overlaps with the support plate. Here, it is assumed that the conductor is stably fixed to the support plate. Measurement is performed for all of the conductors arranged on the support plate or for 20 conductors or more.

### Width a of Flat Portion of Conductor

In the cross section of the conductor, a straight line that passes through the flat portions of the respective conductors and that is approximately parallel to the upper surface of the support plate is drawn, and a length of each of the flat portions along the straight line is measured. The length is defined as the width A of each of the flat portions of the conductors. For each of the conductors, the width A of the flat portion of the conductor is compared with the radius r of the conductor of the cable main body portion. When r<A is satisfied for 50% or more of the measured conductors in one support plate, the multi-core cable is regarded as having a relationship of r<A between the radius r of the conductor in the cable main body portion and the width A of the flat portion of the conductor.

### Maximum Height D1 of Conductor

A contour line of a conductor cross section is checked and measured. The maximum height D1 of the conductor is obtained by measuring a distance between the flat portion of the conductor and a point on the contour line at which a distance from the flat portion is maximum is measured in a direction perpendicular to the flat portion of the conductor.

### Maximum Width D2 of Conductor in Direction Parallel to Flat Portion

The maximum value of the width of the contour of conductor in the direction parallel to the flat portion of the conductor is defined as the maximum width D2 of the conductor. When the connection surface side of the conductor has a unique shape portion such as a flange shape or a protrusion as described in FIGS. 12 and 13, the maximum width D2 of the conductor is measured in such a manner that a general shape portion of the conductor is measured without measuring the unique shape portion. The respective maximum heights D1 and maximum widths D2 of the conductors are compared with each other. When a relationship of D1<D2 is satisfied for 50% or more of the measured conductors, the multi-core cable is regarded as having a relationship of D1<D2 between the maximum height D1 of the conductor and the maximum width D2 of the conductor in the direction parallel to the flat portion of the conductor. In addition, when a relationship 1.0<(D2/D1)<2.0 is satisfied for 50% or more of the measured conductors, the multi-core cable is regarded as having a relationship in which the ratio (D2/D1) of the maximum width D2 of the conductor in the direction parallel to the flat portion of the conductor to the maximum height D1 of the conductor is 1.0<(D2/D1)<2.0.

### Cross-Sectional Area of Groove in Support Plate

The cross-sectional area of the groove in the support plate may be measured simultaneously with measurement of the conductor cross-sectional shape. Referring back to FIG. 14, an area enclosed by the straight line S along the upper surface of the support plate and the contour line of the inner surface of the groove in the support plate is defined as a cross-sectional area of the groove. When the inside of the groove contains an insulating material different from a material of the support plate main body, such as an adhesive, the contour line of the insulating material is treated as the contour line of the groove, and an area occupied by the insulating material is excluded from the cross-sectional area of the groove. The cross-sectional areas of the respective grooves and the respective conductors corresponding to the grooves are compared with each other. When the cross-sectional area of the groove is 97% or less of the cross-sectional area of the conductor in 50% or more of a combination of the measured grooves and conductors, the multi-core cable is regarded as having a configuration in which the cross-sectional area of the groove is 97% or less of the cross-sectional area of the conductor in the cable connection portion. Further, when the cross-sectional area of the groove is 40% to 97% of the cross-sectional area of the conductor in 50% or more of a combination of the measured grooves and the conductors, the multi-core cable is regarded as having a configuration in which the cross-sectional area of the groove is 40% to 97% of the cross-sectional area of the conductor in the cable connection portion.

### Interval P Between Grooves in Support Plate

The interval P between the grooves in the support plate may be measured simultaneously with measurement of the conductor cross-sectional shape. A distance between a central portion of a width of an opening portion of a groove on the straight line S along the upper surface of the support plate and a central portion of a width of an opening portion of an adjacent groove is defined as the interval P between the grooves in the support plate. When 50% or more of the measured intervals P between the grooves is within a predetermined range, the multi-core cable is regarded as having an interval between the grooves formed in the support plate within the predetermined range.

### First Embodiment

An insulated cable is prepared in such a manner that an insulator made of PFA was coated on the outer circumference of a conductor having an outer diameter of 0.040 mm, and 12 pieces of the insulated cables were arranged in parallel. The tip of the cable was stripped by 3.0 mm so as to expose a terminal portion of a conductor. A polyimide film having a width of 1.5 mm, a length of 0.5 mm, and a thickness of 50 μm was prepared as a material for the support plate, and grooves were formed by laser processing with the interval P of 0.1 mm therebetween.

The exposed terminal portions of the conductors were respectively arranged in the processed grooves in the support plate and were aligned according to the arrangement of the grooves. The conductors arranged on the support plate were pressed from above the support plate using a small press machine, and the conductors and the grooves were fitted together, thereby forming flat portions on the respective conductors. In this manner, it is possible to obtain a multi-core cable including a support plate.

The vicinity of the terminal processing portion of the obtained multi-core cable was embedded in a hardened resin, and a cross section of the terminal processing portion was created by cutting, in a direction perpendicular to the longitudinal direction of the terminal processing portion, the terminal processing portion in the vicinity of a central portion in the longitudinal direction of a first region in which the terminal portion of the conductor and the support plate overlap each other. Each measurement was performed on the terminal processing portions of the multi-core cable. As a result of measurement, the radius r of each of the conductors in the cable main body portion was 0.02 mm, and the width A of each of the flat portions of the conductors ranged from 0.034 mm to 0.038 mm. Further, the maximum height D1 of each of the conductors ranged from 0.022 to 0.024 mm, the maximum width D2 of each of the conductors ranged from 0.038 mm to 0.040 mm, and D2/D1 ranged from 1.58 to 1.7. The cross-sectional area of the groove was 70% of the cross-sectional area of the conductor in the cable connection portion, and a difference (an absolute value) between the cross-sectional area of the conductor in the cable main body portion and the cross-sectional area of the conductor in the cable connection portion was within 0.5% of the cross-sectional area of the conductor in the cable main body portion.

### Second Embodiment

In a second embodiment, the outer diameter of the conductor in the first embodiment was changed to 0.030 mm. Cables were prepared and arranged in parallel, and the tips of the cables were stripped in the same manner as in the first embodiment. As in the first embodiment, a polyimide film was prepared, and a support plate was created in such a manner that the width and depth of a groove were changed according to the outer diameter of a conductor so as to adjust the cross-sectional area of the groove, and the interval P between the grooves was set to 0.1 mm. A multi-core cable including the support plate was created by using the above-described created support plate through the same procedures as in the first embodiment. The vicinity of the terminal processing portion of the obtained multi-core cable was embedded in a hardened resin, and a cross section of the terminal processing portion was created by cutting, in a direction perpendicular to the longitudinal direction of the terminal processing portion, the terminal processing portion in the vicinity of a central portion in the longitudinal direction of a first region in which the terminal portion of the conductor and the support plate overlap each other. Each measurement was performed on the terminal processing portions of the multi-core cable. As a result of measurement, the radius r of each of the conductors in the cable main body portion was 0.015 mm, and the width A of each of the flat portions of the conductors ranged from 0.025 mm to 0.029 mm. Further, the maximum height D1 of each of the conductors ranged from 0.016 to 0.017 mm, the maximum width D2 of each of the conductors ranged from 0.030 mm to 0.031 mm, and D2/D1 ranged from 1.76 to 1.92. The cross-sectional area of the groove was 50% of the cross-sectional area of the conductor in the cable connection portion, and a difference (an absolute value) between the cross-sectional area of the conductor in the cable main body portion and the cross-sectional area of the conductor in the cable connection portion was within 0.5% of the cross-sectional area of the conductor in the cable main body portion.

### Third Embodiment

In a third embodiment, the outer diameter of the conductor in the first embodiment was changed to 0.025 mm. Cables were prepared and arranged in parallel, and the tips of the cables were stripped in the same manner as in the first embodiment. As in the first embodiment, a polyimide film was prepared, and a support plate was created in such a manner that the width and depth of a groove were changed according to the outer diameter of a conductor so as to adjust the cross-sectional area of the groove, and the interval P between the grooves was set to 0.05 mm. A multi-core cable including the support plate was created by using the above-described created support plate through the same procedures as in the first embodiment. The vicinity of the terminal processing portion of the obtained multi-core cable was embedded in a hardened resin, and a cross section of the terminal processing portion was created by cutting, in a direction perpendicular to the longitudinal direction of the terminal processing portion, the terminal processing portion in the vicinity of a central portion in the longitudinal direction of a first region in which the terminal portion of the conductor and the support plate overlap each other. Each measurement was performed on the terminal processing portions of the multi-core cable. As a result of measurement, the radius r of each of the conductors in the cable main body portion was 0.0125 mm, and the width A of each of the flat portions of the conductors ranged from 0.0214 mm to 0.0231 mm. Further, the maximum height D1 of each of the conductors ranged from 0.0243 to 0.0246 mm, the maximum width D2 of each of the conductors ranged from 0.0265 mm to 0.0269 mm, and D2/D1 ranged from 1.07 to 1.11. The cross-sectional area of the groove was 87% of the cross-sectional area of the conductor in the cable connection portion, and a difference (an absolute value) between the cross-sectional area of the conductor in the cable main body portion and the cross-sectional area of the conductor in the cable connection portion was within 0.5% of the cross-sectional area of the conductor in the cable main body portion.

An anisotropic conductive film was placed on the support plate and the upper portions of the conductors of the multi-core cable obtained in the first embodiment, was heated to about 80° C., and was laminated on the support plate. The anisotropic conductive sheet was formed of a film based on epoxy resin, in which the film has nickel-plated conductive particles dispersed in resin particles. The conductors placed on the support plate and the electrode portions of the substrate are arranged so as to correspond to each other with the anisotropic conductive film interposed therebetween, and the support plate and the substrate were electrically connected to each other by heating to about 200° C. and applying pressure to the support plate and the substrate from above and below. All of the conductors arranged on the support plate may be collectively connected to the correct positions.

The length of the cable was set to 1000 mm. As a result of measuring a resistance value of each electrically connected circuit, the multi-core cable obtained in the first embodiment had a stable resistance value within ±0.1 Ω of a measured value of conductor resistance.

Furthermore, since the support plate has a high holding strength for the conductors, detachment of the conductors from the respective grooves in the support plate was not observed during operation or transportation.

### First Comparative Example

In a first comparative example, cables were prepared and arranged in parallel, and the tips of the cables were stripped in the same manner as in the first embodiment. A polyimide film was prepared and a support plate was created in the same manner as in the first embodiment. The exposed terminal portions of the conductors were respectively arranged in the grooves in the processed support plate and aligned according to arrangement of the grooves. The conductors were not pressed by a small press machine, and an anisotropic conductive film was placed on the support plate and the upper portions of the conductors, was heated to about 80° C., and was laminated on the support plate. The anisotropic conductive sheet used in the first comparative example was the same as in the first embodiment. The conductors placed in the support plate and the electrode portions of the substrate are arranged so as to correspond to each other with the anisotropic conductive film interposed therebetween, and the support plate and the substrate were electrically connected to each other by heating to about 200° C. and applying pressure to the support plate and the substrate from above and below.

The length of the cable was set to 1000 mm. As a result of measuring a resistance value of each electrically connected circuit, the multi-core cable obtained in the first comparative example had a difference of 41.2 Ω between the maximum and minimum resistance values of each circuit, resulting in a large variation in resistance values.

The reason why the resistance value is not stable in the multi-core cable of the first comparative example is that, since a connection area between the conductor and the electrode portion is very small in the ultra-thin cable, in the sample of the first comparative example, which does not have a flat portion of the conductor, the curved surface of the conductor may not accurately contact the electrode portion when the conductor and the electrode portion are joined. Conversely, it was confirmed that the multi-core cable of the embodiment obtained a stable resistance value, and the cable had excellent stability and reliability in terms of electrical connection between the conductor and the electrode portion.

Since the conductors of the multi-core cable of the present invention are capable of being respectively connected to the fine electrode portions arranged at high density on the substrate, it is possible to achieve excellent stability and reliability in terms of electrical connection between the conductors and the electrode portions. In addition, connection work between the electrode portions and the conductors is simply performed, and the multi-core cable of the present invention is highly effective in reducing the size of an area around a substrate connection portion. Additionally, the multi-core cable of the present invention may be used in various fields requiring miniaturization and high precision of devices such as a medical probe cable, a micromachine, a measuring device, and a communication device.

### DESCRIPTION OF REFERENCE NUMERALS

1: Multi-core cable
10: Ultra-thin cable
100: Conductor
110: Ultra-thin insulated cable
120: Ultra-thin coaxial cable
20: Support plate
200: Plate
210: Groove
300: Anisotropic conductive film
40: Substrate
400: Electrode portion

1. A multi-core cable comprising a plurality of ultra-thin cables, each of the ultra-thin cables comprising a conductor and an insulator coated on an outer circumference of the conductor, wherein:
the multi-core cable comprises a cable main body portion and a cable terminal processing portion,
the cable terminal processing portion comprises terminal portions of at least three ultra-thin cables among the plurality of ultra-thin cables and a support plate,
the terminal portions of the ultra-thin cables are exposed terminal portions of the conductors,
the support plate has a first side and a second side opposite the first side,
the support plate has a plurality of grooves formed in at least an upper surface thereof, each of the grooves extending in a direction from the first side toward the second side,
each of the terminal portions of the conductors comprises a first region and a second region, the first region being a region overlapping with the support plate, the second region being a region not overlapping with the support plate,
the first region has at least a part of the terminal portions of the conductors respectively located in the grooves in the support plate,
Some or all of the conductors respectively located in the grooves in the support plate have respective flat portions approximately parallel to the upper surface of the support plate, and
the conductors respectively located in the grooves in the support plate satisfy a relationship of r<A (Equation (1)) with respect to two or more of the conductors in the same cross-section, wherein r is a radius of the conductor in the cable main body portion, and A is a width of the flat portion of the conductor.

2. The multi-core cable according to claim 1, wherein a cross-sectional shape of each of the conductors located in a corresponding one of the grooves in the support plate is configured such that a ratio (D2/D1) of a maximum width D2 of the conductor in a direction parallel to the flat portion of the conductor to a maximum height D1 of the conductor in a direction perpendicular to the flat portion of the conductor is 1.0<(D2/D1)<2.0.

3. The multi-core cable according to claim 1, wherein the terminal portions of the conductors are arranged in parallel at least in the first region.

4. The multi-core cable according to claim 1, wherein each of the conductors in the cable main body portion has an outer diameter ranging from 0.01 mm to 0.15 mm.

5. The multi-core cable according to claim 1, wherein a difference between a cross-sectional area of the conductor in the cable main body portion and a cross-sectional area of the terminal portion of the conductor located in the groove in the support plate is within 10.0% of the cross-sectional area of the conductor in the cable main body portion.

6. The multi-core cable according to claim 1, wherein a cross-sectional area of the groove in the support plate is 40% to 97% of a cross-sectional area of the conductor located in the groove in the support plate.

7. The multi-core cable according to claim 1, wherein an interval between the grooves in the support plate ranges from 0.04 mm to 1.0 mm.

8. The multi-core cable according to claim 1, wherein the support plate is formed of an insulating material.

9. The multi-core cable according to claim 1, wherein the conductors respectively located in the grooves in the support plate and electrode portions on a connection substrate are electrically connected to each other with an anisotropic conductive film interposed therebetween.

10. An electronic device comprising the multi-core cable according to claim 1.

11. A method of manufacturing a multi-core cable, the method comprising the steps of:
preparing a plurality of ultra-thin cables, each of the ultra-thin cables comprising a conductor and an insulator coated on an outer circumference of the conductor;
removing the insulators of terminal portions of the plurality of ultra-thin cables and exposing the conductors;
preparing a support plate having a first side and a second side opposite the first side, the support plate having a plurality of grooves formed in at least an upper surface thereof, each of the grooves extending in a direction from the first side toward the second side;
arranging the conductors exposed by removing the respective insulators in the respective grooves formed in the support plate; and
pressing the conductors arranged in the respective grooves from above the support plate to fit the conductors into the respective grooves in the support plate, and forming flat portions on the respective conductors arranged in the grooves, the flat portions being formed to be approximately parallel to the upper surface of the support plate.
